(19) United States
(12) Patent Application Publication
(10) Pub. No.: US 2026/0136325 A1
(43) Pub. Date: May 14, 2026

(54) SYSTEMS AND METHODS FOR SIDELINK POSITIONING FOR DEVICE-TO-DEVICE COMMUNICATIONS

(71) Applicant: ZTE CORPORATION, Shenzhen, Guangdong (CN)

(72) Inventors: Mengzhen LI, Shenzhen (CN); Chuangxin JIANG, Shenzhen (CN); Qi YANG, Shenzhen (CN); Yu PAN, Shenzhen (CN); Youxiong LU, Shenzhen (CN); Cong WANG, Shenzhen (CN); Junpeng LOU, Shenzhen (CN); Weimin XING, Shenzhen (CN)

(73) Assignee: ZTE CORPORATION, Shenzhen, Guangdong (CN)

(21) Appl. No.: 19/443,585

(22) Filed: Jan. 8, 2026

Related U.S. Application Data
(63) Continuation of application No. PCT/CN2023/112668, filed on Aug. 11, 2023.

(51) Int. Cl. H04W 64/00; H04L 5/00; H04W 4/44; H04W 92/18

(52) U.S. Cl. CPC H04W 64/00; H04L 5/0048; H04W 4/44; H04W 92/18

(57) ABSTRACT

The present disclosure relates to systems, apparatuses, methods, and non-transitory computer-readable media for receiving, by a first wireless communication device from a higher layer, Sidelink Positioning Reference Signal (SL PRS) resource configuration for communicating SL PRS in a time-domain unit and sending, by the first wireless communication device, the SL PRS according to the SL PRS resource configuration to a second wireless communication device.

### CROSS-REFERENCE TO RELATED APPLICATION

This application claims the benefit of priority under 35 U.S.C. § 120 as a continuation of PCT Patent Application No. PCT/CN2023/112668, filed on Aug. 11, 2023, the disclosure of which is incorporated herein by reference in its entirety.

### TECHNICAL FIELD

The disclosure relates generally to wireless communications and, more particularly, to device-to-device communications.

### BACKGROUND

Sidelink (SL) communication refers to wireless radio communication between two or more User Equipments (UEs). In this type of communications, two or more UEs that are geographically proximate to each other can communicate without being routed to a network (e.g., Base Station (BS)) or a core network. Data transmissions in SL communications are thus different from typical cellular network communications that include transmitting data to a BS and receiving data from a BS. In SL communications, data is transmitted directly from a source UE to a target UE through, for example the Unified Air Interface (e.g., PC5 interface) without passing through a BS.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

Some arrangements of the present disclosure relate to systems, methods, apparatuses, and non-transitory computer-readable media relating to receiving, by a first wireless communication device from a higher layer, Sidelink Positioning Reference Signal (SL PRS) resource configuration for communicating SL PRS in a time-domain unit and sending, by the first wireless communication device, the SL PRS according to the SL PRS resource configuration to a second wireless communication device.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication system, according to various arrangements.

FIG. 1B is a diagram illustrating a block diagram of an example wireless communication system for transmitting and receiving downlink, uplink, and/or SL communication signals, according to various arrangements.

FIG. 2 illustrates an example scenario for SL communications, according to various arrangements.

FIG. 3 is a flowchart diagram illustrating an example method for communicating SL positioning-related transmission, according to various arrangements.

FIG. 4 is a diagram illustrating an example allocation of time-domain resources and frequency-domain resources for transmitting SL PRSs of multiple UEs in a structure for a single slot, according to various arrangements.

FIG. 5 is a diagram illustrating an example allocation of time-domain resources and frequency-domain resources for transmitting SL PRSs of multiple UEs in a structure for a single slot and a structure for a single slot, according to various arrangements.

FIG. 6 is a diagram illustrating an example allocation of time-domain resources and frequency-domain resources for transmitting SL PRSs of multiple UEs in a structure, according to various arrangements.

FIG. 7 is a diagram illustrating an example allocation of time-domain resources and frequency-domain resources for transmitting SL PRSs of multiple UEs in a structure, according to various arrangements.

FIG. 8 is a diagram illustrating an example allocation of time-domain resources and frequency-domain resources for transmitting SL PRSs of multiple UEs in a structure, according to various arrangements.

FIG. 9 is a diagram illustrating an example allocation of time-domain resources and frequency-domain resources for transmitting SL PRSs of multiple UEs in a structure, according to various arrangements.

FIG. 10 is a signaling diagram illustrating an example method synchronization for UE-based positioning, according to various arrangements.

FIG. 11 is a signaling diagram illustrating an example method synchronization for UE-based positioning, according to various arrangements.

FIG. 12 is a flowchart diagram illustrating an example method for configuring and communicating SL PRS and SCI, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional network-centric cellular networks have limited high data rate capabilities and support for proximity services. In this context, device-to-device (D2D) communications emerge to address the shortcomings of the network-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSe), unilateral/sidechain/SL communication, and so on.

In some arrangements, wireless communications can be performed on carriers, frequency bands, and/or frequency spectrums. Some carriers are licensed carriers as they are licensed by a government or another authoritative entity to a service provider for exclusive use. Some carriers are unlicensed carriers, which are not licensed by any government or authoritative entities for exclusive use. Two or more service providers may operate in an unlicensed carrier. Currently, UEs may communicate directly with each other (e.g., without doing so using a base station) on the licensed carriers. No schemes have been provided for UEs to communicate with each other on unlicensed carriers.

In some arrangements, a licensed carrier refers to a carrier, frequency band, or spectrum that is licensed by a government or an authoritative entity, such as the Federal Communications Commission (FCC) in the United States and the European Telecommunications Standards Institute (ETSI) in Europe, to a service provider for exclusive use. An unlicensed carrier (or shared spectrum) refers to a carrier, frequency band, or spectrum that is not licensed by a government or another authoritative entity. Two or more service providers may operate in the unlicensed carrier.

Solutions for supporting SL positioning in NR systems include SL positioning reference signals (e.g., SL Positioning Reference Signal (SL PRS)), measurements and reporting for SL positioning considering various positioning methods (e.g., Round Trip Time (RTT), Time Difference Of Arrival (TDOA), angle-based positioning methods, and so on), and resource allocation for SL PRS, considering both dedicated resource pool for SL PRS and shared resource pool, and considering both resource allocation scheme 1 and scheme 2.

Different from Physical SL Control Channel (PSCCH) and Physical SL Shared Channel (PSSCH) resource allocation in SL communications in which the time granularity is slot and the frequency granularity is sub-channel, SL PRS resource and/or SL PRS resource set can be defined and used as resource allocation granularity. The mechanism of SL PRS sequence configuration, congestion control for SL positioning, and Inter-UE Coordination (IUC) can be defined accordingly.

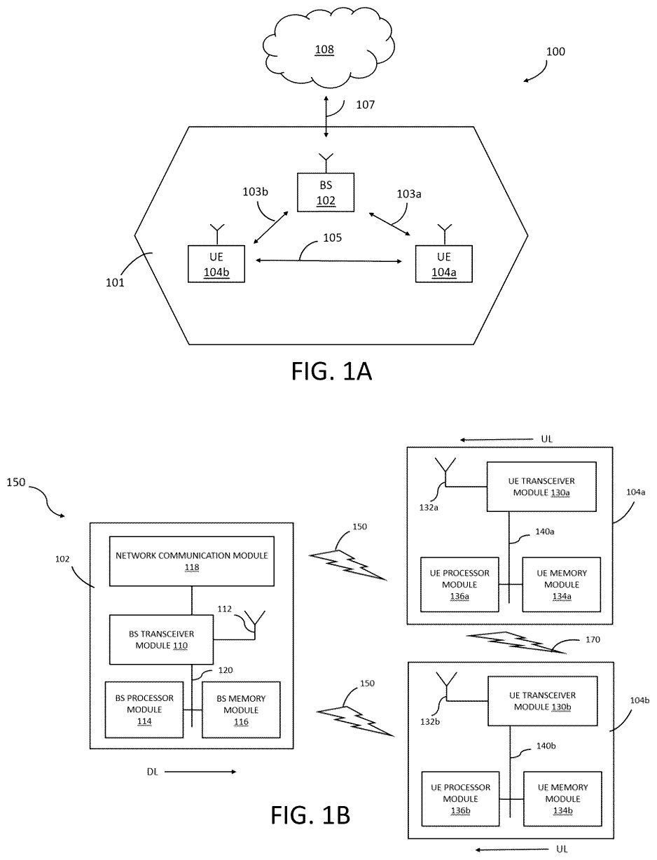

Referring to FIG. 1A, an example wireless communication system 100 is shown. The wireless communication system 100 illustrates a group communication within a cellular network. In a wireless communication system, a network side communication node or a network can include a next Generation Node B (gNB), an E-UTRAN Node B (also known as Evolved Node B, eNodeB or eNB), a pico station, a femto station, a Transmission/Reception Point (TRP), an Access Point (AP), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In some examples, a UE can be a vehicle UE, a pedestrian UE, a Road-Side UE (RSU), a Positioning Reference Unit (PRU), and so on. A UE described herein can implement the methods described herein with or without a known location. In FIG. 1A, a network side and a terminal side communication node are represented by a network 102 and UEs 104a and 104b, respectively. In some arrangements, the network 102 and UEs 104a/104b are sometimes referred to as “wireless communication node” and “wireless communication device,” respectively. Such communication nodes/devices can perform wireless communications.

In the illustrated arrangement of FIG. 1A, the network 102 can define a cell 101 in which the UEs 104a and 104b are located. The UEs 104a and/or 104b can be moving or remain stationary within a coverage of the cell 101. The first UE04a can communicate with the network 102 via a communication channel 103a. Similarly, the first UE04b can communicate with the network 102 via a communication channel 103b. In addition, the UEs 104a and 104b can communicate with each other via a communication channel 105. The communication channels 103a and 104b between a respective UE and the network can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, vehicle network communications modes can be collective referred to as Vehicle-to-Everything (V2X) communications. The network 102 is connected to Core Network (CN) 108 through an external interface 107, e.g., an Iu interface.

In some examples, a remote UE (e.g., the first UE04b) that does not directly communicate with the network 102 or the CN 108 (e.g., the communication channel link 103b is not established) communicates indirectly with the network 102 and the CN 108 using the SL communication channel 105 via a relay UE (e.g., the first UE04a), which can directly communicate with the network 102 and the CN 108 or indirectly communicate with the network 102 and the CN 108 via another relay UE that can directly communicate with the network 102 and the CN 108.

FIG. 1B illustrates a block diagram of an example wireless communication system for transmitting and receiving downlink, uplink and SL communication signals, in accordance with some arrangements of the present disclosure. In some arrangements, the system can transmit and receive data in a wireless communication environment such as the wireless communication system 100 of FIG. 1A, as described above.

The system generally includes the network 102 and UEs 104a and 104b, as described in FIG. 1A. The network 102 includes a network transceiver module 110, a network antenna 112, a network memory module 116, a network processor module 114, and a network communication module 118, each module being coupled and interconnected with one another as necessary via a data communication bus 120. The first UE04a includes a UE transceiver module 130a, a UE antenna 132a, a UE memory module 134a, and a UE processor module 136a, each module being coupled and interconnected with one another as necessary via a data communication bus 140a. Similarly, the first UE04b includes a UE transceiver module 130b, a UE antenna 132b, a UE memory module 134b, and a UE processor module 136b, each module being coupled and interconnected with one another as necessary via a data communication bus 140b. The network 102 communicates with the UEs 104a and 104b via one or more of a communication channel 150, which can be any wireless channel or other medium known in the art suitable for transmission of data as described herein.

The system may further include any number of modules other than the modules shown in FIG. 1B. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a and 104b to an antenna of the network 102 is known as an uplink transmission, and a wireless transmission from an antenna of the network 102 to an antenna of one of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter and receiver circuitry that are each coupled to the respective antenna 132a and 132b. A duplex switch may alternatively couple the uplink transmitter or receiver to the uplink antenna in time duplex fashion. Similarly, the network transceiver module 110 may be herein referred to as a downlink transceiver, or network transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 150 at the same time that the downlink transmitter is coupled to the antenna 112. In some arrangements, the UEs 104a and 104b can use the UE transceivers 130a and 130b through the respective antennas 132a and 132b to communicate with the network 102 via the wireless communication channel 150. The wireless communication channel 150 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the network transceiver 110 are configured to communicate via the wireless data communication channel 150, and cooperate with a suitably configured antenna arrangement that can support a particular wireless communication protocol and modulation scheme. In some arrangements, the UE transceiver 130a and 130b and the network transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the network transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein may be embodied directly in hardware, in firmware, in a software module executed by processor modules 114 and 136a and 136b, respectively, or in any practical combination thereof. The memory modules 116 and 134a and 134b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b may be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 116, 134a, and 134b, respectively. Memory modules 116, 134a, and 134b may also each include non-volatile memory for storing instructions to be executed by the processor modules 114 and 136a and 136b, respectively.

The network interface 118 generally represents the hardware, software, firmware, processing logic, and/or other components of the network 102 that enable bi-directional communication between network transceiver 110 and other network components and communication nodes configured to communication with the network 102. For example, the network interface 118 may be configured to support internet or WiMAX traffic. In a typical deployment, without limitation, the network interface 118 provides an 802.3 Ethernet interface such that network transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the network 102 to communicate with other network s or core network over a wired or wireless connection.

In some arrangements, each of the UEs 104a and 104b can operate in a hybrid communication network in which the UE communicates with the network 102, and with other UEs, e.g., between 104a and 104b. As described in further detail below, the UEs 104a and 104b support SL communications with other UE's as well as downlink/uplink communications between the network 102 and the UEs 104a and 104b. In general, the SL communication allows the UEs 104a and 104b to establish a direct communication link with each other, or with other UEs from different cells, without requiring the network 102 to relay data between UEs.

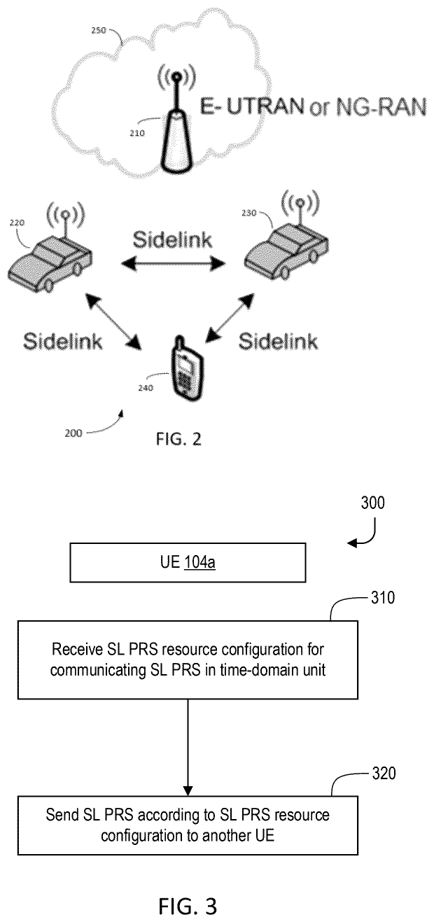

FIG. 2 is a diagram illustrating an example system 200 for SL communication, according to various arrangements. As shown in FIG. 2, a network 210 (such as network 102 of FIG. 1A) broadcasts a signal that is received by a first UE 230, a second UE 230, and a third UE 240. The UEs 220 and 230 in FIG. 2 are shown as vehicles with vehicular communication networks, while the UE 240 is shown as a mobile device. As shown by the SLs, the UEs 220-240 are able to communicate with each other (e.g., directly transmitting and receiving) via an air interface without forwarding by the base station 210 or the core network 250. This type of V2X communication is referred to as PC5-based V2X communication or V2X SL communication.

As used herein, when two UEs 104a or 104b are in SL communications with each other via the communication channel 105/170, the UE that is transmitting data to the other UE is referred to as the transmission (TX or Tx) UE, and the UE that is receiving said data is referred to as the reception (RX or Rx) UE.

For PSCCH/PSSCH resource allocation in SL communications, the time granularity (e.g., a slot and a sub-channel) is defined as a PSSCH frequency-domain resource unit. The size of sub-channel is configured for each resource pool. Moreover, both SL Channel Busy Ratio (CBR) and SL Channel Occupancy Ratio (CR) used for SL congestion control are defined based on sub-channel busy or sub-channel occupancy ratio. For SL positioning, SL PRS allocation granularity can apply slot-based and sub-channel-based SL PRS resource allocation, sub-slot-based SL PRS resource allocation, or SL PRS-resource-based allocation.

With regards to SL PRS resource allocation, both scheme 1 (e.g., network-centric operation SL PRS resource allocation) and scheme 2 (e.g., UE autonomous SL PRS resource allocation) support SL positioning/ranging.

FIG. 3 is a flowchart diagram illustrating an example method 300 for configuring and communicating SL PRS, according to various arrangements. The method 300 can be performed using the systems 100 and 200. At 310, the UE 104a receives from the higher layer the SL PRS resource configuration for communicating the SL PRS in the time-domain unit. At 330, the UE 104a sends the SL PRS according to the SL PRS resource configuration to another UE such as the second UE (e.g., the UE 104b or a second wireless communication device).

In some arrangements, starting symbols can be aligned across multiple resource pools. In dedicated resource pools, Time Division Multiplexing (TDM)-based multiplexing of SL PRSs from different UEs in a slot can be supported. In order to further increase the multiplexing capacity of UEs in a slot, both TDM-based multiplexing and comb-based multiplexing of SL PRSs from UEs can be pre-configured or configured in a single slot.

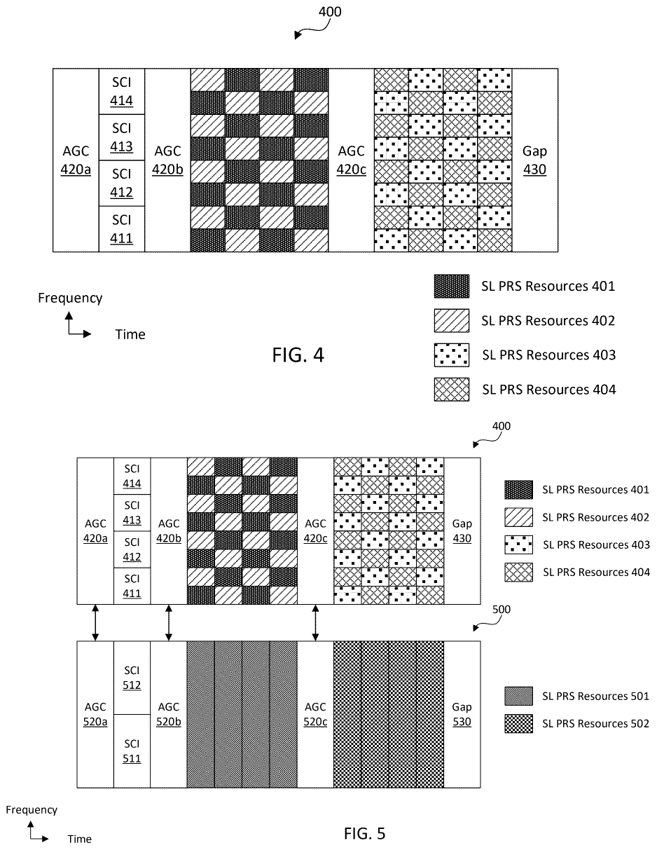

FIG. 4 is a diagram illustrating an example allocation of time-domain resources and frequency-domain resources for transmitting SL PRSs of multiple UEs in a structure 400 for a single slot, according to various arrangements. The horizontal or x dimension denotes time-domain resources, and the vertical or y dimension denotes frequency-domain resources. As shown in FIG. 4, SL PRS resources 401 and SL PRS resource 402 are comb-based multiplexed in the same symbols. SL PRS resources 403 and SL PRS resource 404 are comb-based multiplexed in the same symbols. The SL PRS resources 401 and 402 are TDM-ed with SL PRS resources 403 and 404. Different UEs can use the SL PRS resources 401, 402, 403, and 404 to transmit SL PRSs. As shown, the structure 400 for a slot includes Sidelink Control Information (SCI) 411, 412, 413, and 414 that respectively correspond to (e.g., scheduling) the SL PRS resources 401, 402, 403, and 404. The SCIs 411, 412, 413, and 414 are between the Automatic Gain Control (AGC) blocks 420a and 420b in the time domain. The SL PRS resources 401 and 402 are between the AGC symbols 420b and 420c in the time domain. The SL PRS resources 403 and 404 are between the AGC symbols 420c and gap 430 in the time domain.

Moreover, in order to avoid AGC issues, time-domain resources for SL PRS are aligned among multiple resource pools. A time-domain resource for SL PRS includes and is defined by at least one of a time-domain starting point (e.g., a starting symbol) of the SL PRS and a time-domain length (e.g., a number of symbols in a slot for the SL PRS), a location of SL PRS resource in a slot. The multiple resource pools can be at least one or more of: dedicated resource pool for SL positioning, shared resource pool. The multiple resource pools can be FDMed in one SL frequency-domain resource (e.g., Bandwidth Part (BWP)).

In some arrangements, time-domain configuration of a SL PRS resource of the first UE (e.g., the UE 104a) is aligned with a time-domain configuration of a SL PRS resource of a plurality of UEs. The SL PRS resource of the first UE is Time Division Multiplexed (TDMed), comb-based multiplexed, or both TDMed and comb-based multiplexed with the SL PRS resource of the plurality of UEs within the time-domain unit. The SL PRS resource is configured within a resource pool, the resource pool is a dedicated resource pool or a shared resource pool. In some examples, the time-domain unit is a slot. The SL PRS resource configuration is received from the higher layer via signaling including at least one of a Long Term Evolution Positioning Protocol (LPP) from a Location Management Function (LMF), a Sidelink Positioning Protocol (SLPP) from the LMF or a UE, Radio Access Control (RRC) or Medium Access Control (MAC) from the BS 102, the higher layer of the first UE (the higher layer includes at least one of a MAC layer, an RRC layer, or a Non-Access Stratum (NAS) layer), or the SL PRS resource configuration is pre-configured.

In some arrangements, the SL PRS resource configuration includes a time-domain configuration. The time-domain configuration includes at least one of a time-domain starting point, a time-domain length, or a SL PRS resource location in the time-domain unit.

FIG. 5 is a diagram illustrating an example allocation of time-domain resources and frequency-domain resources for transmitting SL PRSs of multiple UEs in a structure 400 for a single slot and a structure 500 for a single slot, according to various arrangements. The horizontal or x dimension denotes time-domain resources, and the vertical or y dimension denotes frequency-domain resources. The slot structure 400 that is described in FIG. 4 includes SL PRS resources 401, 402, 403, and 404 that are in a first resource pool.

For the slot structure 500, the SL PRS resources 501 are TDM-ed with SL PRS resources 502. An SL PRS resource 501 and an SL PRS resource 502 use the same frequency-domain resource. Different UEs can use the SL PRS resources 501 and 502 to transmit SL PRSs. As shown, the structure 500 for a slot includes SCI 511 and 512 that respectively correspond to (e.g., scheduling) the SL PRS resources 501 and 502. The SCIs 511 and 512 are between the AGC symbols 520a and 520b in the time domain. The SL PRS resources 501 are between the AGC symbols 520b and 520c in the time domain. The SL PRS resources 502 are between the AGC symbols 520c and gap 530 in the time domain. The SL PRS resources 501 and 502 are in a second resource pool.

The SL PRS resources 401, 402, 403, and 404 in a first resource pool and the SL PRS resources 501 and 502 are in a second resource pool can be FDMed. In some examples, SL PRS resources 401, 402, 403, and 404 pre-configured or configured in the first resource pool and SL PRS resources 501 and 502 pre-configured or configured in the second resource pool can be transmitted in the same time-domain resource (e.g., a same slot as shown). Even though the SL PRS resources 401, 402, 403, 404, 501, and 502 are different in different resource pools, their corresponding AGC symbols 420a, 420b, 420c, 520a, 520b, and 520c or the starting symbol of SL PRS resources 401, 402, 403, 404, 501, and 502 are aligned.

In some examples, the time-domain resources for communicating SL PRS across multiple resource pools can be aligned. In some arrangements, the network pre-configures or configures the AGC symbol location in a slot is pre-configured or configured by at a BWP level, at a carrier level, or across the carriers for Carrier Aggregation (CA). In some examples, the AGC time-domain resource (e.g., the AGC symbol) is defined as one of an AGC time-domain resource preceding a SL PRS resource, an AGC time-domain resource preceding a PSCCH resource, or a starting symbol used for SL positioning in a slot. In some examples, the network pre-configures or configures a location in a slot of each AGC symbol for each SL BWP. In some arrangements, in the method 300, the UE 104a receives a location for an AGC resource in the time-domain unit for each of at least one or a plurality resource pool, for each of at least one frequency-domain resource (e.g., BWP), for each of at least one carrier, or for a plurality of carriers used in CA. In some arrangements, the AGC resource is defined by at least one of an AGC time-domain resource preceding one of the SL PRS resources, an AGC time-domain resource preceding a resource used in communicating a PSCCH, or a starting time used for SL positioning in the time-domain resource.

In some arrangements, the network pre-configures or configures time-domain resources for SL PRS in a slot at a BWP level, a carrier level, or across the carriers for CA for each SL BWP. In some examples, the network pre-configures or configures a location in a slot of each time-domain resource for SL PRS. In some arrangements, the SL PRS resource configuration comprises configurations for time-domain SL PRS resources in the time-domain unit for each of at least one or a plurality of resource pools, for each of at least one frequency-domain resource, for each of at least one carrier, or for a plurality of carriers used in CA.

In some arrangements, the network pre-configures or configures time-domain resources for SL PRS in a slot in each resource pool. The resource pool can be either SL PRS dedicated resource pool or shared resource pool. In some examples, the time-domain resources for SL PRS are aligned among multiple resource pools.

In some arrangements, time resources for SL PRS can be aligned across multiple UEs in one resource pool, the resource pool can be at least one or more of dedicated resource pool, shared resource pool. Two time-domain resources align as the starting locations of both time-domain resources are the same and/or the ending locations of both time-domain resources are the same. Considering resource pools for SL positioning and resource pools for SL communication can be (pre-)configured in one SL BWP, but TDM based multiplexing between different UEs' SL data in a slot is not supported. It is hard to guarantee the same AGC symbol location in a slot for both SL communication resource pool and SL PRS resource pool.

In some arrangements, time resource for SL PRS can be aligned across UEs at multiple-resource-pool level. In other words, the starting symbols for SL PRS resources or the AGC symbol location within a slot can be aligned for all resource pools for SL positioning.

In some arrangements, for SL PRS transmissions, both SL PRS transmissions with periodic reservation and SL PRS transmission without periodic reservations (e.g., aperiodic reservations) are supported. For SL PRS transmissions with periodic reservation, an SCI can include a resource reservation period field to indicate the periodicity of the same SL-PRS resource.

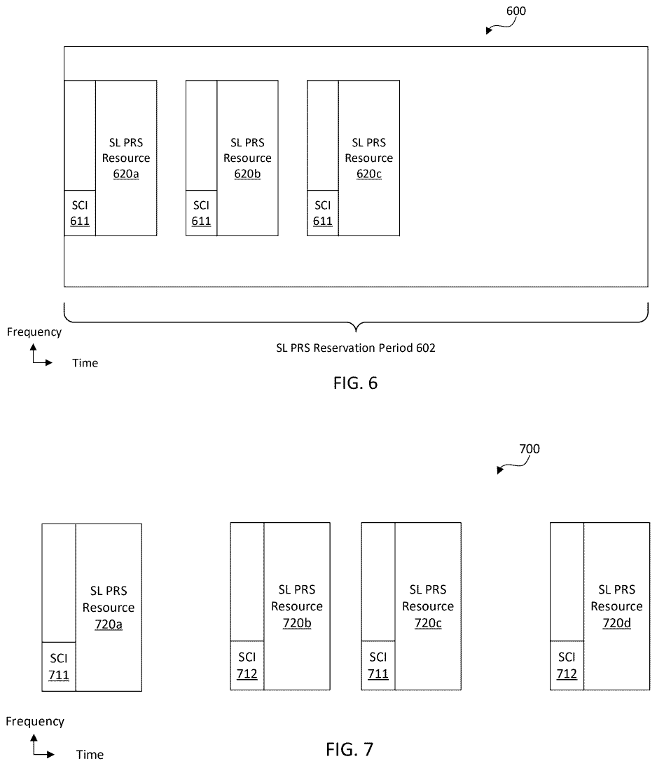

With respect to SL PRS transmissions with aperiodic reservation, the SL PRS resource reservation in the same slot is considered as PSCCH. In some examples, up to N aperiodic resource reservations in other slots can be configured. The number N can be pre-configured or configured by the network in resource pool, e.g., N=2 or 1. FIG. 6 is a diagram illustrating an example allocation of time-domain resources and frequency-domain resources for transmitting SL PRSs of multiple UEs in a structure 600, according to various arrangements. The horizontal or x dimension denotes time-domain resources, and the vertical or y dimension denotes frequency-domain resources. In some arrangements, in an aperiodic reservation scheme, the SCI 611 schedules the SL PRS resource with 3 aperiodic reservations (denoted as SL PRS resources 620a, 620b, and 620c) within one SL PRS reservation period 602.

In some arrangements, there is a one-to-one mapping relationship between a PSCCH resource (a resource for SCI transmission) and a SL PRS resource in a time-domain resource (e.g., a slot). The configuration of which may include the configuration of time resource (e.g., number of slots), frequency resource (e.g., number of Physical Resource Block (PRBs)), Demodulation Reference Signal (DMRS) scramble ID and number of reserved bits. In some examples, for future aperiodic reservation, all aperiodic SL PRS reservations indicated in one SCI have the same SL PRS resource ID, and there is no need to additionally include SL PRS resource ID(s) information in the SCI. In other words, multiple aperiodic reserved SL PRS are SL PRS resource repetition. Moreover, the information contained in SCI includes a list of at least one of source ID, destination ID, resource reservation period, cast type, time resource assignment for aperiodic reserved SL PRS. For example, in FIG. 6, all SL PRS resources 620a, 620b, and 620c have a same SL PRS resource ID, e.g., 1, and the SCI 611 does not include any SL PRS resource ID.

In some examples, for future aperiodic reservation, a number of SL PRS resource IDs indicated in SCI is less than a number of reserved SL PRS resources that indicated by the SCI by 1. In some arrangements, the information contained in SCI includes a list of at least one of source ID, destination ID, resource reservation period, cast type, time resource assignment for aperiodic reserved SL PRS. In some arrangements, the information contained in SCI includes multiple lists with the number of list equal to the number of SL PRS reservations for transmission without periodic reservations or the number of list is more than the number of SL PRS resource ID(s) indicated in the SCI by 1. Each list includes at least one of source ID, destination ID, resource reservation period, cast type, time resource assignment for aperiodic reserved SL PRS. For example, the SCI additionally includes at most 2 SL PRS resource indicated (e.g., 2 SL PRS resource IDs) for future reservation. For example, in FIG. 6, the SL PRS resources 620a, 620b, and 620c have different SL PRS resource IDs, e.g., 1, 2, and 3, respectively.

In some arrangements, there is a one-to-more mapping relationship between a PSCCH resource (a resource for SCI transmission) and one or more SL PRS resources in a slot. In some examples, for future aperiodic reservation, SCI indicates one SL PRS resource to indicate which SL PRS resource is reserved for all aperiodic reservations. The configuration of which may include the configuration of time resource (e.g., number of slots), frequency resource (e.g., number of PRBs), DMRS scramble ID and number of reserved bits. Since there is no one-to one mapping, SCI should still indicate which resource in the same slot is reserved. Moreover, the information contained in SCI includes a list of at least one of source ID, destination ID, resource reservation period, cast type, time resource assignment for aperiodic reserved SL PRS.

In some example, given the one-to-one mapping or one-to-more mapping between a PSCCH resource and one or more SL PRS resource(s), those one or more SL PRS resources mapped to the same PSCCH resource can be seen as a SL PRS resources packet. The PSCCH can only reserve SL PRS resource(s) belonging to the corresponding SL PRS resources packet according to the mapping relationship. For example, suppose PSCCH/SCI resource 1 is mapped with a SL PRS resources packet {SL PRS resource 1, SL PRS resource 2, SL PRS resource 3}, regardless of periodic resource reservation or aperiodic resource reservation, the PSCCH/SCI 1 can only reserve one or more SL PRS resources from the SL PRS resources packet {SL PRS resource 1, SL PRS resource 2, SL PRS resource 3}. In other words, PSCCH/SCI 1 cannot reserve SL PRS resource 4 in either periodic or aperiodic way.

In some examples, for future aperiodic reservation, the SCI can indicate multiple SL PRS resources each of which can be associated with a resource ID. The number of SL PRS resource IDs indicated in SCI is equal to the number of reserved SL PRS resources that indicated by the SCI. For example, if SCI indicate 3 aperiodic SL PRS resources, 3 SL PRS resource IDs should be included in SCI. In some arrangements, the information contained in SCI includes a list of at least one of source ID, destination ID, resource reservation period, cast type, time resource assignment for aperiodic reserved SL PRS. In some arrangements, the information contained in SCI includes multiple lists with the number of list equal to the number of SL PRS reservations for transmission without periodic reservations or equal to the number of SL PRS resource ID(s) indicated in the SCI, wherein each list includes at least one of source ID, destination ID, resource reservation period, cast type, time resource assignment for aperiodic reserved SL PRS.

In some examples, in sensing-based resource selection for SL positioning, an entity such as Medium Access Control (MAC) layer or physical layer is responsible for sensing triggering.

In some arrangements, a physical layer can control the procedure of sensing including triggering pre-emption and re-evaluation of resources. In some examples, a physical layer of a UE can perform tasks of a MAC layer, including determining the timing to begin sensing and determine at least one of a resource pool, priority for SL PRS transmission, a remaining packet delay budget, a SL PRS resource ID, a number of symbols for SL PRS, multiple SL PRS resources (e.g. SL PRS resource ID), one or more PSCCH resource, a SL PRS resource packet including of one or more SL PRS resources associated with a PSCCH resources, a resource reservation interval, a subset of resources for pre-emption or re-evaluation, and so on.

In some arrangements, a higher layer (e.g., a MAC layer) triggers the sensing procedure. For example, a MAC layer of the Tx UE can request the Tx UE to determine a subset of resources. The MAC layer can select resources from the subset of resources for PSSCH/PSCCH transmission based on a physical layer's candidate resources report. In some examples, the MAC layer triggers the sensing procedure and provides at least one or more of a SL PRS resource ID, a number of symbols for SL PRS, multiple SL PRS resources (e.g., SL PRS resource ID), one or more PSCCH resource, a SL PRS resource packet including one or more SL PRS resources associated with a PSCCH resources, resource pool, priority for SL PRS transmission, remaining packet delay budget, the number of sub-channels, resource reservation interval, a subset of resources for pre-emption or re-evaluation, indication of resource selection mechanism, and so on.

In some arrangements in which the higher layer (e.g., MAC layer) requests the UE to determine a subset of resources from which the higher layer selects resources for SL PRS transmission and/or PSCCH/SCI transmission as part of re-evaluation or pre-emption procedure, the higher layer provides a set of resources which may be subject to re-evaluation and a set of resources which may be subject to pre-emption. In some arrangements, for selecting resources for SL PRS transmission and/or PSCCH/SCI transmission UE (e.g., UE's physical layer) determines a set of resources which may be subject to re-evaluation and a set of resources which may be subject to pre-emption.

In some arrangements, based on sensing results (e.g., initial sensing), the UE can determine a set S of candidate resources for SL PRS transmission. The candidate resources can be associated with the same PSCCH resource. In response to determining that a resource from the set for re-evaluation is not a member of the set S, the UE assumes that the resource is removed or dropped. In response to determining that a resource from the set for pre-emption is not a member of the set S and the resource meets the conditions for exclusion in sensing procedure and the priority of the resource is lower than the received SL PRS priority, the UE assumes that the resource is removed or dropped. Determining that priority of the resource is lower than the received SL PRS priority for pre-emption is associated with a higher layer parameter (e.g., sl-prs-PreemptionEnable). The higher layer parameter for pre-emption can be configured or pre-configured in each resource pool, the resource pool can be either dedicated resource pool or shared resource pool. The higher layer parameter can be configured in RRC or LPP or SLPP. The candidate value of this higher layer parameter for pre-emption can include at least one of enable, disable, or one or more priority value. The priority value can be either integer or non-integer.

In some arrangements, for those resources evaluated as re-evaluation or pre-emption (e.g., UE determines the resources are reserved by other UEs and/or the priority of the resource(s) is lower than that of other UEs, or in other words, those resource(s) are determined to be removed to dropped), based on another sensing procedure, the UE replaces the removed or dropped resource(s) by resource(s) which are sensed to be candidate and selected by either MAC layer or physical layer. The removed/dropped resource and the resource(s) to replacing the removed/dropped resources has at least the same SL PRS resource ID, the same associated PSCCH resource, the same PSCCH resource, the same SL PRS resource packet, the same cast type indicator, the same source ID, the same destination ID, the same SL PRS priority. The removed/dropped resource and the resource(s) to replacing the removed/dropped resources are located in different time-domain unit. The time-domain unit can be a slot.

In some examples, in SL positioning resource allocation scheme 2, in order to find resources to replace removed/dropped resources for SL PRS transmission, the UE performs another sensing procedure. In triggering the another sensing procedure, at least one of the following information is the same as the initial sensing procedure: a SL PRS resource ID, a number of symbols for SL PRS, multiple SL PRS resources (e.g. SL PRS resource ID), one or more PSCCH resource, a SL PRS resource packet including of one or more SL PRS resources associated with a PSCCH resources, resource pool, priority for SL PRS transmission, remaining packet delay budget, the number of sub-channels, resource reservation interval, a subset of resources for pre-emption or re-evaluation, indication of resource selection mechanism. The removed/dropped resource and the resource(s) to replacing the removed/dropped resources are located in different time-domain unit. The time-domain unit can be a slot.

In some arrangements, the first wireless communication device performs sensing and selecting a first SL PRS resource, a first SL PRS resource packet, or a first PSCCH resource in a first time-domain unit, for sending SL PRS to the second wireless communication device, wherein at least one of: a first SL PRS resource packet comprises one or more SL PRS resources associated with a PSCCH resource. The first wireless communication device determines a second SL PRS resource, a second resource packet, or a second PSCCH resource in a second time-domain unit to replace the first SL PRS resource, the first SL PRS resource packet, or the first PSCCH resource in the first time-domain unit after pre-emption or re-evaluation. The second SL PRS resource, the second resource packet, or the second PSCCH resource is the same as a respective one of the first SL PRS resource, the first SL PRS resource packet or the first PSCCH resource.

In some arrangements, all aperiodic SL PRS reservations indicated in one SCI have the same SL PRS resource ID. For a Tx UE in resource allocation scheme 2, for its SL PRS transmission, the sensing procedure is performed in order for the transmission of SL PRS resource 1. In the examples in which the Tx UE transmits the first occasion of SCI/SL PRS in slot n and reserve a SL PRS 1 in slot n+t₁, Rx UE (or another UE performing sensing) receives this SCI and determines that the SL PRS resource in slot n+t₁ is occupied. In the example in which the Rx UE (or another UE performing sensing) receives from the Tx UE another SCI indicating that the same SL PRS resource (e.g., SL PRS resource 1) is reserved in a time-frequency-domain resource (e.g., time occasion), which is different from the reservations indicated in the previous SCI received from the network. The Rx UE can determine that the previous reservation is disabled. In the example, one or more of the following can be the same between what indicated in the previous SCI and the following another SCI: source ID, destination ID, cast type, resource reservation period, SL PRS priority. For example, the Rx UE (or another UE performing sensing) can determine that the resource is available for another transmission or its own transmission.

FIG. 7 is a diagram illustrating an example allocation of time-domain resources and frequency-domain resources for transmitting SL PRSs of multiple UEs in a structure 700, according to various arrangements. The horizontal or x dimension denotes time-domain resources, and the vertical or y dimension denotes frequency-domain resources. In some arrangements, the network configures the SCI 711 which schedules the SL PRS resource reservations (denoted as SL PRS resources 720a, 720b, 720c, and 720d). In some examples, the reservations for the SL PRS resources 720a, 720b, 720c, and 720d have the same ID, e.g., SL PRS resource 1. Subsequently, the Rx UE (or another UE performing sensing) receives from the Tx UE another SCI 712 indicating that some of the same SL PRS resources (e.g., SL PRS resources 720b and 720d) are reserved in a time-frequency-domain resource (e.g., time occasion), which is different from the reservations indicated in the previous SCI 711 received from the network. The Rx UE can determine that the previous reservation by the SCI 711 is disabled. For example, the Rx UE (or another UE performing sensing) can determine that the resources 720a and 720c are available for another transmission or its own transmission.

In the example in which the Rx UE (or another UE performing sensing) receives from the Tx UE another SCI indicating that a different SL PRS resource (e.g., SL PRS resource 2) is reserved in a time-frequency-domain resource (e.g., time occasion), which is different from the reservations indicated in the previous SCI received from the network. The Rx UE can determine that the previous reservation is valid. In the example, one or more of the following can be the same between what indicated in the previous SCI and the following another SCI: source ID, destination ID, cast type, resource reservation period, or SL PRS priority.

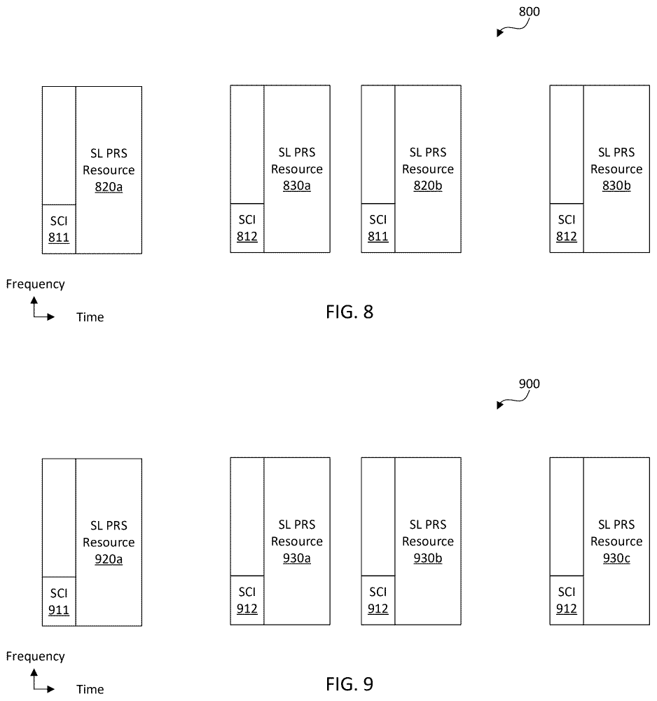

FIG. 8 is a diagram illustrating an example allocation of time-domain resources and frequency-domain resources for transmitting SL PRSs of multiple UEs in a structure 800, according to various arrangements. The horizontal or x dimension denotes time-domain resources, and the vertical or y dimension denotes frequency-domain resources. In some arrangements, the network configures the SCI 811 which schedules the SL PRS resource reservations (denoted as SL PRS resources 820a and 820b). In some examples, the reservations for the SL PRS resources 820a and 820b have the same ID, e.g., SL PRS resource 1. Subsequently, the Rx UE (or another UE performing sensing) receives from the Tx UE another SCI 812 indicating that some of different SL PRS resources (e.g., SL PRS resources 830a and 830b) are reserved in a time-frequency-domain resource (e.g., time occasion), which is different from the reservations indicated in the previous SCI 811 received from the network. In some examples, the reservations for the SL PRS resources 830a and 830b have the same ID, e.g., SL PRS resource 2. The Rx UE can determine that the previous reservation by the SCI 811 is valid.

Overall, from a Rx UE perspective, SL PRS resource ID indicated in SCI or implied by the location of SCI has impact on whether Rx UE determines the SL PRS reservations in previous SCI from the network is valid.

In some arrangements, aperiodic SL PRS reservations indicated in one SCI can be for different SL PRS resources. In the examples in which an Rx UE (or another UE performing sensing) receives from Tx UE another SCI indicating that the same SL PRS resource (e.g., SL PRS resource 2) is reserved in a time-frequency-domain resource (e.g., time occasion) which is different from the location of reservations for the same SL PRS resource indicated in previous SCI, the Rx UE can assume the previous reservation from the network is disabled. In the example, one or more of the following can be the same between what indicated in the previous SCI and the following another SCI: source ID, destination ID, cast type, resource reservation period, SL PRS priority.

FIG. 9 is a diagram illustrating an example allocation of time-domain resources and frequency-domain resources for transmitting SL PRSs of multiple UEs in a structure 900, according to various arrangements. The horizontal or x dimension denotes time-domain resources, and the vertical or y dimension denotes frequency-domain resources. In some arrangements, the network configures the SCI 911 which schedules the SL PRS resource reservations (denoted as SL PRS resources 920a and 930b). In some examples, the reservations for the SL PRS resource 920a has a first ID, e.g., SLPRS resource 1 and the SL PRS resource 930b has a second ID, e.g., SL PRS resource 2. Subsequently, the Rx UE (or another UE performing sensing) receives from the Tx UE another SCI 912 indicating that SL PRS resources 930a, 930b, and 930c are reserved in a time-frequency-domain resource (e.g., time occasion), which is different from the reservations indicated in the previous SCI 911 received from the network. In some examples, the reservations for the SL PRS resources 930a, 930b, and 930c have the same ID. The Rx UE can determine that the previous reservation by the SCI 911 is disable. For example, the Rx UE (or another UE performing sensing) can determine that the resource 910a is available for another transmission or its own transmission.

In some arrangements in which the Rx UE (or another UE performing sensing) receives from the Tx UE another SCI indicating that one or more different SL PRS resources (e.g., SL PRS resource 3, 4) is reserved compared to the SL PRS resource indicated in previous SCI, Rx UE can assume the previous reservation is valid. In the example, one or more of the following can be the same between what indicated in the previous SCI and the following another SCI: source ID, destination ID, cast type, resource reservation period, SL PRS priority. For example, in FIG. 8, subsequent to receiving the SCI 811, the Rx UE (or another UE performing sensing) receives from the Tx UE another SCI 812 indicating that one or more different SL PRS resources (e.g., SL PRS resources 830a and 830b) are reserved in a time-frequency-domain resource (e.g., time occasion). In some examples, the reservations for the SL PRS resource 820a has an ID of 1, the SL PRS resource 830a has an ID of 2, the SL PRS resource 820b has an ID of 3, and the SL PRS resource 830b has an ID of 4. The Rx UE can determine that the previous reservation by the SCI 811 is valid.

In some arrangements in which the Tx UE transmits PSCCH/SCI resource 1 in slot n and reserves one or more SL PRS resource(s) in future slots, the Rx UE (or another UE performing sensing) receives this SCI and assumes that the SL PRS resource(s) in the future slots is occupied. In response to the Rx UE (or another UE performing sensing) receiving another PSCCH/SCI resource from the Tx UE in a slot different from slot n indicating SL PRS reservations, and the another PSCCH/SCI resource is the same as the previous PSCCH/SCI resource 1 in slot n, the Rx UE can assume that the pervious reservation is disabled. In other words, the new PSCCH/SCI's SL PRS reservation can override the previous PSCCH/SCI's SL PRS reservation. In the example, one or more of the following can be the same between the previous PSCCH/SCI and the following another PSCCH/SCI: source ID, destination ID, cast type, resource reservation period, or the SL PRS priority.

In some arrangements in which Tx UE transmits PSCCH/SCI resource 1 in slot n and reserves one or more SL PRS resource(s) in future slots, the Rx UE (or another UE performing sensing) receives this SCI and assumes that the SL PRS resource(s) in the future slots is occupied. In response to the Rx UE (or another UE performing sensing) receiving another PSCCH/SCI resource from the Tx UE in a slot different from slot n indicating SL PRS reservations, and the another PSCCH/SCI resource is different from the previous PSCCH/SCI resource 1 in slot n, the Rx UE can assume that the pervious reservation is still valid. In the example, one or more of the following can be the same between the previous PSCCH/SCI and the following another PSCCH/SCI: source ID, destination ID, cast type, resource reservation period, or SL PRS priority.

In some arrangements, the method 300 further includes sending, by the first UE (e.g., the UE 104a) to a plurality of UEs, SCI to indicate a number of SL PRS reservations for transmissions with or without periodic reservation. In some arrangements, a resource for transmitting the SCI and a SL PRS resource in the time-domain unit are mapped via a one-to-one mapping relationship. In some arrangements, a resource for transmitting the SCI and multiple SL PRS resources in the time-domain unit are mapped via a one-to-more mapping relationship. In some arrangements, the second UE (e.g., the UE 104b) is one of the plurality of UEs. In some arrangements, the SCI reserves only a SL PRS resource belonging to a SL PRS resource packet. The SL PRS resource packet includes one or more SL PRS resources mapped to the resource for transmitting the SCI.

In some arrangements, the method 300 further includes sending, by the first wireless communication device to one of a plurality of UEs, a SCI includes a number of SL PRS resource IDs. The number of SL PRS resource IDs is less than the number of SL PRS reservations for transmissions without periodic reservation by 1.

In some arrangements, the method 300 further includes sending, by the first UE to one of a plurality of UEs, a SCI including a number of SL PRS resource IDs. The number of SL PRS resource IDs is equal to the number of SL PRS reservations for transmissions without periodic reservation. In some arrangements, the method 300 further includes sending, by the first UE to one of a plurality of UEs, a SCI including one or multiple list of information. The information includes at least one or more of: source ID, destination ID, resource reservation period, SL PRS priority, or cast type.

In some arrangements, for transmitting the SL PRS a physical layer of the first UE determines at least one of one or more SL PRS resources, a resource for transmitting SCI, a number of time-domain resources, a resource pool from which the one or more SL PRS resources are to be transmitted, a priority for SL PRS transmission, a remaining packet delay budget, a resource reservation period, or a subset of resources for pre-emption and re-evaluation.

In some arrangements, for transmitting the SL PRS, a high layer of the first wireless communication device determines at least one of one or more SL PRS resources, a resource for transmitting SCI, a number of time-domain resources, a resource pool from which the one or more SL PRS resources are to be transmitted, a priority for SL PRS transmission, a remaining packet delay budget, a resource reservation period, or a subset of resources for pre-emption and re-evaluation. The higher layer includes at least one of a MAC layer, a RRC layer, or a NAS layer.

In some arrangements, the second UE (e.g., the UE 104b) receives reservation from the first UE (e.g., the UE 104a) of a first one or more SL PRS resources via a first SCI in a first time-domain unit. The second UE receives reservation of one or more SL PRS resources which is the same as the first one or more SL PRS resources from the first wireless communication device via a second SCI in a second time-domain unit. The second UE determines that the reservation with respect to the first one or more SL PRS resources indicated in the first SCI is invalid.

In some arrangements, the second UE (e.g., the UE 104b) receives reservation from the first UE (e.g., the UE 104a) of a first one or more SL PRS resource(s) via a first SCI in a first time-domain unit. The second UE receives reservation of one or more SL PRS resource(s) different from the first one or more SL PRS resource(s) from the first UE via a second SCI in a second time-domain unit. The second UE determines that the reservation with respect to the first one or more SL PRS resource(s) indicated in the first SCI is valid.

In some arrangements, the second UE (e.g., the UE 104b) receives reservation from the first UE of a first one or more SL PRS resource(s) via a first SCI in a first time-domain unit. The second UE receives reservation of a second one or more SL PRS resources from the first UE via a second SCI in a second time-domain unit. The first SCI and the second SCI are the same PSCCH resource. The second UE determines that the reservation with respect to the first one or more SL PRS resources indicated in the first SCI is invalid.

In some arrangements, the second UE (e.g., the UE 104b) receives reservation from the first UE (e.g., the UE 104a) of a first one or more SL PRS resource(s) via a first SCI in a first time-domain unit. The second UE receives reservation of a second one or more SL PRS resources from the first wireless communication device via a second SCI in a second time-domain unit. The first SCI and the second SCI is different PSCCH resources. The second UE determines that the reservation with respect to the first one or more SL PRS resources indicated in the first SCI is valid.

In some arrangements, the first SCI and the second SCI have at least one of a same source ID, a same destination ID, a same cast type, a same resource reservation period, or a same SL PRS priority.

In some arrangements, the impact of synchronization errors between UEs can be mitigated. In some examples, a server UE can be used for positioning method determination, anchor UE selection, assistance distribution, and/or location calculation in resource allocation scheme 2. The server UE can be used to deliver Channel Access Priority Class (CAPC) configuration to the Tx UE. In some examples, either the anchor UE or target UE or any UEs can be the server UE. For example, in DL-like SL-Time Difference of Arrival (TDOA) positioning, multiple anchor UEs transmit SL PRS to a target UE respectively. Once one anchor UE successfully occupies one Channel Occupancy Time (COT), the anchor UE can share this COT to other anchor UEs involved. In some examples, all the anchor UEs involved in one SL-TDOA positioning are in a group.

Exchanging of synchronization information of anchor UEs between a UE (e.g., a first UE) and a Location Management Function (LMF) or another UE (second UE) can be supported to mitigate the impact of synchronization errors. The time synchronization information can include both information of a reference UE (e.g., UE ID, the reference time, the quality of the timing of reference UE, and so on) and the relative synchronization time offset (including the quality) between reference UE and a list of anchor UEs.

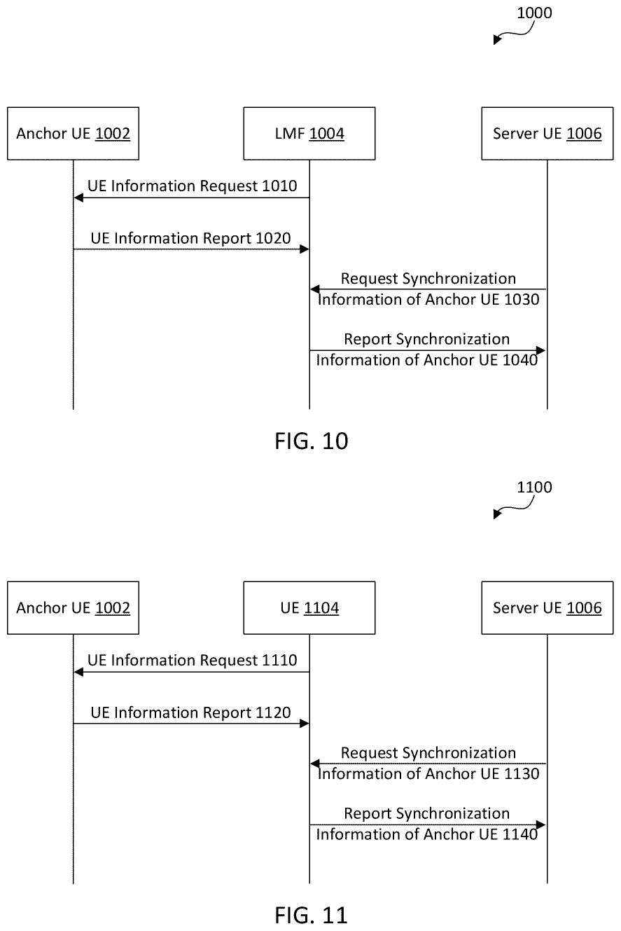

In some examples, the LMF delivers synchronization information of an anchor UE to a UE via Long Term Evolution Positioning Protocol (LPP) signaling or via SLPP for UE-based positioning. FIG. 10 is a signaling diagram illustrating an example method 1000 synchronization for UE-based positioning, according to various arrangements. The method 1000 can be performed by an anchor UE 1002, an LMF 1004, and a server UE 1006, according to various arrangements. While one anchor UE 1002 is shown and described, the method 1000 is applicable to multiple anchor UEs, each of which can be the anchor UE 1002.

In some arrangements, at 1010, the LMF 1004 sends a UE information request 1010 to the anchor UE 1002. At 1020, the anchor UE 1002 transmits UE information report (e.g., UE information) to the LMF 1004 via LPP signaling or via SLPP signaling. The UE information can include at least one of UE ID, timing information (e.g., System Frame Number (SFN), Direct Frame Number (DFN)), SFN initialization time, synchronization reference source, NR Physical Layer Cell ID (PCI), NR Cell Global Identify (CGI), NR Absolute Radio Frequency Channel Number (ARFCN), SL PRS configuration, geographical coordinates, Antenna Reference Point (ARP) geographical coordinates, UE type (e.g., whether the anchor UE 1002 can be a server UE), UE Tx Timing Error Group (TEG) association, UE Tx ARP association, and so on for the anchor UE 1002.

In some examples, the LMF 1004 can send the UE information request to the anchor UE 1002 via LPP or via SLPP at 1010. The UE information request signaling can include one or more of UE ID, timing information (e.g., SFN, DFN), SFN initialization time, synchronization reference source, NR PCI, NR CGI, NR ARFCN, SL PRS configuration, geographical coordinates, ARP geographical coordinates, UE type (e.g., whether the anchor UE can be a server UE), UE Tx TEG association, UE Tx ARP association.

In some examples, the server UE 1006 can send a synchronization information request to the LMF 1004 via LPP or via SLPP, to obtain information on the timing offset among different anchor UEs 1002. For example, at 1030, the server UE 1006 sends a request synchronization information of the anchor UE 1002 to the LMF 1004. At 1040, the LMF 1004 sends the information for the anchor UEs 1002 received at 1020 to the server UE 1006.

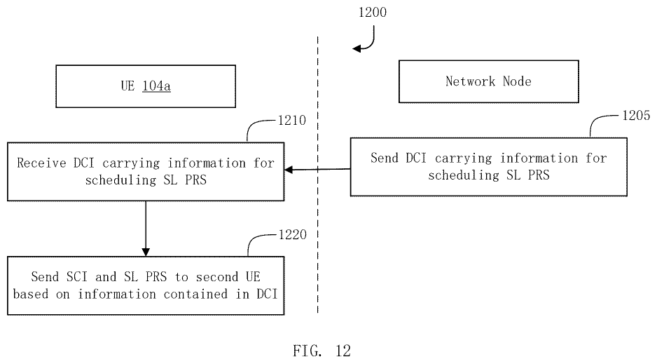

In some examples, another UE (e.g., a second UE) delivers synchronization information of anchor UEs to the UE (first UE) via Sidelink Positioning Protocol (SLPP). FIG. 11 is a signaling diagram illustrating an example method 1100 synchronization for UE-based positioning, according to various arrangements. The method 1100 can be performed by an anchor UE 1002, a UE 1104, and a server UE 1006, according to various arrangements. While one anchor UE 1002 is shown and described, the method 1100 is applicable to multiple anchor UEs, each of which can be the anchor UE 1002.

At 1110, the UE 1104 sends a UE information request 1110 to the anchor UE 1002 via SLPP. At 1120, the anchor UE 1002 transmits the UE information report 1120 including UE information to the UE 1104 via SLPP. The UE information can include at least one of UE ID, timing information (e.g., SFN, DFN), SFN initialization time, synchronization reference source, NR PCI, NR CGI, NR ARFCN, SL PRS configuration, geographical coordinates, ARP geographical coordinates, UE type (e.g., whether the anchor UE can be a server UE), UE Tx TEG association, or UE Tx ARP association of the anchor UE 1002. The UE information request signaling can include one or more of the following UE ID, timing information (e.g., SFN, DFN), SFN initialization time, synchronization reference source, NR PCI, NR CGI, NR ARFCN, SL PRS configuration, geographical coordinates, ARP geographical coordinates, UE type (e.g., whether the anchor UE can be a server UE), UE Tx TEG association, or UE Tx ARP association.

In some examples, the server UE 1006 can send a synchronization information request to the UE 1104 via LPP, to obtain information on the timing offset among different anchor UEs 1002. For example, at 1130, the server UE 1006 sends a request synchronization information of the anchor UE 1002 to the UE 1104. At 1140, the UE 1104 sends the information for the anchor UEs 1002 received at 1120 to the server UE 1006.

In some arrangements, the method 300 further includes receiving, by the first UE (e.g., the UE 104a) from a device, a UE information request via LPP or SLPP. In some arrangements, the method 300 further includes transmitting, by the first wireless communication device to a device, a UE information report via the LPP or the SLPP.

In some arrangements, the UE information request or report comprising at least one of UE ID, SFN, DFN, SFN initialization time, synchronization reference source, NR PCI, NR CGI, NR ARFCN, SL PRS configuration, geographical coordinates, ARP geographical coordinates, UE type, UE Tx TEG association, or UE Tx ARP association for an anchor UE.

In some examples, the device includes an LMF. In some examples, the device includes another UE. In some examples, the method 300 further includes sending, by the device to a UE, synchronization information between a plurality of UEs and a reference UE or between a plurality of UEs and a reference network device based on the UE information reports of the plurality of UEs. The first UE is one of the plurality of UEs.

In some examples, the synchronization information includes at least one of: information of reference UE, reference UE ID, the reference timing of reference UE, SFN of reference UE, DFN of the reference UE, UTC time, physical cell ID, global cell ID, ARFCN, quality of the timing of the reference UE, UE ID of the plurality of UEs, synchronization timing offset between the reference and one of the plurality of UEs, or a quality of synchronization timing offset.

In some arrangements, as for the SL PRS sequence ID

$${n}_{ID , s e q}^{SL PRS}$$

configuration, both

$${n}_{ID , s e q}^{SL PRS}$$

provided by higher layer and

$${n}_{ID , seq}^{SL PRS}$$

based on 12 Least Significant Bits (LSBs) Cyclic Redundancy Check (CRC) of PSCCH associated of the SL PRS are supported. Both PSCCH DMRS and SL PRS can be the candidate Reference Signal (RS) for sensing. In sensing procedure, the sensing RS can be pre-configured or configured per resource pool and used for deriving Reference Signal Received Power (RSRP) to further compare the measured RSRP with a threshold.

In some examples, the SL PRS has a greater bandwidth and therefore can result in more accurate RSRP measurement compared with PSCCH DMRS-based RSRP. In order to use SL PRS as the sensing RS and at the same time avoid resource collision, SL PRS RSRP cannot be measured by UEs without sequence ID information.

In some examples,

$${n}_{ID , seq}^{SL PRS}$$

is based on 12 LSB bits CRC of PSCCH associated of the SL PRS and higher layer configured SL PRS sequence ID is not allowed.

In some examples in which UEs has a SL PRS sequence ID provided by higher layer, those UEs broadcast its SL PRS sequence ID. The broadcast signaling can be at least one of a SCI, SLPP, and so on. Each SL PRS sequence ID broadcasted by such UE can be associated with a SL PRS resource or associated with the transmission location of a SL PRS resource. The transmission location can be a slot number, a symbol number, a frequency domain allocation, and so on.

The anchor UE's ARP location information can be contained in anchor UE location information. The ARP location information of anchor UE is the relative position of ARP(s) to the anchor UE and each ARP location is associated with an ARP ID. Moreover, anchor UE can provide the ARP location information of SL PRS resource in assistance data.

In some arrangements, the first UE (e.g., the UE 104a) sends SL PRS to the second UE (e.g., UE 104b) based on a SL PRS sequence ID. The first UE receives the SL PRS sequence UE from a higher layer via signaling. The signaling includes at least one of LPP from an LMF, SLPP from the LMF or a UE, RRC from the BS 102, or the SL PRS resource configuration is pre-configured. The higher layer of the first wireless communication device, wherein the higher layer comprises at least one of a MAC layer, an RRC layer, or a NAS layer. In some arrangements, the first UE broadcasts the SL PRS sequence ID to a plurality of wireless communication devices via at least one of SCI or SLPP.

In some examples, the method 300 further includes reporting, by the first UE or the second UE to a device, ARP location information. The ARP location information includes a relative position of at least one ARP compared to a location of the first UE or the second UE. Each ARP location is associated with an ARP ID. In some examples, the device includes an LMF or another UE.

In some arrangements, in SL PRS resource allocation scheme 1, instead of choosing resources by sensing or random resource selection, a transmitting UE can receive a SL PRS resource allocation from gNB via a Downlink Control Information (DCI). Both dedicated resource pool and shared resource pool can be used for SL positioning. In some arrangements, the DCI can distinguish the dedicated resource pool and shared resource pool.

In some arrangements, the same DCI format or the same Radio Network Temporary Identifier (RNTI) (e.g., a DCI format with CRC scrambled by the same RNTI) is used for both dedicated resource pool and shared resource pool. In some example, the resource pool index indicator can be used to indicate whether the fields/indicators included in this DCI is used for SL PRS transmission in dedicated resource pool or used for SL PRS transmission in shared resource pool. In some examples, the bits occupied by a resource pool index is related to the total number of both shared resource pools and dedicated resource pools for transmission SL PRS.

In some arrangements, the same DCI format or the same RNTI (e.g., a DCI format with CRC scrambled by the same RNTI) is used for both dedicated resource pool and shared resource pool, in some example, an extra bit “SL PRS resource pool type” can be introduced to indicate whether this DCI is used for scheduling SL PRS transmission in dedicated resource pool or shared resource pool. If shared resource pool is indicated, the bis occupied by “resource pool index” is related to the total number of shared resource pools for transmission SL PRS; if dedicated resource pool is indicated, the bis occupied by “resource pool index” is related to the total number of both shared resource pools and dedicated resource pools for transmission SL PRS; in some example, the DCI format can be DCI format 3-0 or a new DCI format.

In some arrangements, based on whether UE is scheduled to transmit SL PRS in shared resource pool or in dedicated resource pool, different DCI format or different RNTI (e.g., a DCI format with CRC scrambled by different RNTI) are applied for scheduling SL PRS transmission in shared resource pool or in dedicated resource pool respectively. Despite of which methods is applied for DCI format/RNTI design for dedicated resource pool and shared resource pool, at least one of the following designs for detailed fields in DCI should be applied. If dedicated resource pool and shared resource pool shared the same DCI format or the same RNTI, only a few fields related to scheduling SL PRS in dedicated resource pool is activated or enable or transmitted by the DCI if it is intended for dedicated resource pool, only a few fields related to scheduling SL PRS in shared resource pool is activated or enable or transmitted by the DCI if it is intended for shared resource pool.

FIG. 12 is a flowchart diagram illustrating an example method 1200 for configuring and communicating SL PRS and SCI, according to various arrangements. The method 1200 can be performed using the systems 100 and 200.

At 1210, a first UE (e.g., the UE 104a) receives from a network node (e.g., the BS 102), a DCI carrying information for scheduling of SL PRS. At 1220, the first UE sends to a second UE (e.g., the UE 104b) a SCI and the SL PRS based on the information contained in the DCI. In some arrangements, the DCI is used to schedule SL PRS transmission of the first UE either in a dedicated resource pool or in a shared resource pool. In some arrangements, the same DCI format or the same RNTI is used for both the DCI scheduling SL PRS in dedicated resource pool and shared resource pool. An indicator is indicated in the DCI to indicate the resource pool type. In some arrangements, the DCI for scheduling SL PRS in dedicated resource pool and the DCI for scheduling SL PRS in shared resource pool have different DCI format or are attached with CRC scrambled by different RNTI.

In some arrangements, if the resource pool index field indicates that this DCI is used for scheduling SL PRS transmission in shared resource pool, if the SL PRS resource pool type field indicates that this DCI is used for scheduling SL PRS transmission in shared resource pool, or if the DCI format or the RNTI implies/indicates that this DCI is used for scheduling SL PRS transmission in shared resource pool, at least one or more of the following should be used for this DCI design: (1) an SL data indicator can be introduced in the DCI, for example, the number of bit of the SL data indicator is 1 which indicates whether this DCI is used for scheduling SL PRS transmission only or is used for scheduling both SL PRS transmission and SL data transmission; (2) there are only one DCI format used for shared resource pool, where different RNTI are used for two cases: scheduling SL PRS transmission only or is used for scheduling both SL PRS transmission and SL data transmission; (3) to indicate which SL PRS resource is scheduled for transmission, a new field SL PRS resource ID can be introduced in the DCI, where the number of bits for the field SL PRS resource ID is related to the total number of SL PRS resources configured in the shared resource pool for transmission; (4) T=to indicate both which SL PRS resource is scheduled for transmission and whether SL data is also scheduled, a new field SL data and SL PRS resource field can be introduced in the DCI, wherein the number of bits for the field “SL PRS resource ID” is related to the total number of SL PRS resources configured in the shared resource pool for transmission; for example, “0” means SL PRS resource 1 with SL data and “1” means SL PRS resource 2 with SL data, . . . , “n” means SL PRS resource 1 without SL data, “n+1” means SL PRS resource 2 without SL data, . . . (5) to indicate which SL PRS resource is scheduled for transmission, the SL PRS resource ID can be associated or mapped with the HARQ process number. The mapping relationship can be configured in RRC signaling or it is up to pre-configuration, in some example, the mapping relationship between HARQ process number and SL PRS resource ID can be configured in resource pool, or another dedicated RRC signaling. In such case, if this DCI is only used for scheduling SL PRS transmission, the HARQ process number field can be used to indicated the SL PRS resource ID. If this DCI is used for scheduling both SL PRS transmission and SL data transmission, the HARQ process number field can be used for indicating HARQ process number for SL communication and indicating SL PRS resource ID for SL positioning; (6) if SL PRS only is scheduled by this DCI, the PUCCH indicator can either: not be included in the DCI or if PUCCH resource indicator included the UE is only expected to send ACK feedback to the gNB.

In some arrangements, for shared resource pool, a new 2^{nd} stage SCI is introduced to indicate either only SL PRS or both SL PRS and SL-SCH (e.g., SL data for SL communication). At least one or more of the following should be indicated in this new 2^{nd} stage SCI: (1) an SL data indicator can be introduced in the SCI, for example, the number of bits of the SL data indicator is 1 which indicates whether this SCI is used for scheduling SL PRS transmission only or is used for scheduling both SL PRS transmission and SL data transmission; (2) to indicate which SL PRS resource is scheduled for transmission, a new field SL PRS resource ID can be introduced in the SCI, wherein the number of bits for the field SL PRS resource ID is related to the total number of SL PRS resources configured in the shared resource pool for transmission; (3) to indicate both which SL PRS resource is scheduled for transmission and whether SL data is also scheduled, a new field SL data and SL PRS resource field can be introduced in the SCI, where the number of bits for the field SL PRS resource ID is related to the total number of SL PRS resources configured in the shared resource pool for transmission; for example, “0” means SL PRS resource 1 with SL data and “1” means SL PRS resource 2 with SL data, . . . , “n” means SL PRS resource 1 without SL data, “n+1” means SL PRS resource 2 without SL data; (4) to indicate which SL PRS resource is scheduled for transmission, the SL PRS resource ID can be associated or mapped with the HARQ process number. The mapping relationship can be configured in RRC signaling or it is up to pre-configuration, in some example, the mapping relationship between HARQ process number and SL PRS resource ID can be configured in resource pool, or another dedicated RRC signaling. In such case, if this SCI is only used for scheduling SL PRS transmission, the HARQ process number field can be used to indicated the SL PRS resource ID. If this SCI is used for scheduling both SL PRS transmission and SL data transmission, the HARQ process number field can be used for indicating HARQ process number for SL communication and indicating SL PRS resource ID for SL positioning.

In some arrangements, if the DCI or the SCI is used to indicate SL PRS transmission of the wireless communication device in a shared resource pool, the DCI contains or applies at least one of: different RNTI for two cases: scheduling SL PRS transmission only or scheduling both SL PRS transmission and SL data transmission, a field to indicate whether this DCI is used for dedicated resource pool or shared resource pool, a field to indicate a time gap, a field to indicate frequency resource assignment, a field to indicate time resource assignment, a field to indicate whether this DCI is used for scheduling SL PRS transmission only or is used for scheduling both SL PRS transmission and SL data transmission, a field to indicate one or more SL PRS resource ID, a field to indicate Hybrid Automatic Repeat request (HARQ) process number to indicate either the HARQ process number or both HARQ process number and SL PRS resource ID wherein there are mapping relationship (pre-)configured between HARQ process number and SL PRS resource ID, a field to indicate PUCCH resource wherein if only SL PRS transmission is scheduled, the wireless communication device only send Acknowledgement (ACK) in PUCCH to the network node, a field to indicate configuration index.

In some arrangement, if the resource pool index field indicates that this DCI is used for scheduling SL PRS transmission in a dedicated resource pool, or if the SL PRS resource pool type field indicates that this DCI is used for scheduling SL PRS transmission in dedicated resource pool, or if the DCI format or the RNTI implies/indicates that this DCI is used for scheduling SL PRS transmission in dedicated resource pool, at least one or more of the following methods should be used for this DCI design: (1) if there are one-to-one mapping relationship (pre-)configured between a PSCCH resource and an associated SL PRS resource, and if the aperiodic reservations in SCI are the same SL PRS resource, DCI need to indicate the location of SCI for the first/initial SL PRS transmission. For example, DCI indicates the lowest index of the subchannel allocation of the initial/first transmission or indicates the PSCCH resource ID or indicated the lowest PRB index and the number of PRBs of the PSCCH. There is no need to include frequency resource assignment field or SL PRS resource ID field in the DCI; (2) if there are one-to-one mapping relationship (pre-)configured between a PSCCH resource and an associated SL PRS resource, and if the aperiodic reservations in SCI are the same SL PRS resource, DCI need to indicate the information regarding the SL PRS resource, for example, DCI can include a SL PRS resource ID field where the bits number is related to the total number of SL PRS resources configured in the dedicated resource pool for transmission. There is no need to include frequency resource assignment field or the location of SCI for the first/initial SL PRS transmission field in the DCI; (3) DCI indicates frequency resource assignment field and the location of SCI for the first/initial SL PRS transmission field, for example, if there are one-to-one mapping relationship (pre-)configured between a PSCCH resource and an associated SL PRS resource, and if the aperiodic reservations in SCI are different SL PRS resources; (4) DCI indicates one or more SL PRS resource ID field, for example, if there are one-to-one mapping relationship (pre-)configured between a PSCCH resource and an associated SL PRS resource, and if the aperiodic reservations in SCI are different SL PRS resources; (5) DCI indicates SL PRS resource ID field and the location of SCI for the first/initial SL PRS transmission field, for example, if there are one-to-more mapping relationship (pre-)configured between a PSCCH resource and one or more associated SL PRS resource, and if the aperiodic reservations in SCI are the same SL PRS resource; (6) DCI indicates SL PRS resource ID field and the location of SCI for the first/initial SL PRS transmission field and frequency resource assignment field, for example, if there are one-to-more mapping relationship (pre-)configured between a PSCCH resource and one or more associated SL PRS resource, and if the aperiodic reservations in SCI are different SL PRS resources.

In some arrangements, if the DCI is used to indicate SL PRS transmission of the wireless communication device in a dedicated resource pool, the DCI contains or applies at least one of: a field to indicate whether this DCI is used for dedicated resource pool or shared resource pool, a field to indicate a time gap, a field to indicate one or more SL PRS resource ID, a field to indicate the location of SCI for the first/initial SL PRS transmission, a field to indicate frequency resource assignment, a field to indicate time resource assignment, a field to indicate one or more PSCCH resource, a field to indicate Hybrid Automatic Repeat request (HARQ) process number to indicate either the HARQ process number or both HARQ process number and SL PRS resource ID wherein there are mapping relationship (pre-)configured between HARQ process number and SL PRS resource (e.g., SL PRS resource ID), a field to indicate Hybrid Automatic Repeat request (HARQ) process number to indicate either the HARQ process number or both HARQ process number and PSCCH resource ID wherein there are mapping relationship (pre-)configured between HARQ process number and PSCCH resource (e.g., PSCCH resource ID), the PSCCH resource can indicate a frequency domain and time domain configuration of a SCI. The mapping relationship between HARQ process or SL process and the SL PRS/PSCCH resource can be configured in RRC signaling or it is up to pre-configuration; a field to indicate configuration index.

At 1205, the network node (e.g., the BS 102) sends to the first UE (e.g., the UE 104a) a DCI carrying information for scheduling of SL PRS.

In some examples, For SL-PRS only scheduling or SL-PRS+data scheduling, a new RNTI can be introduced, e.g. DCI format 3_0 with CRC scrambled by SL-PRS-RNTI or SL-PRS-CS-RNTI. It is noted that the legacy RNTI with DCI format 3_0 can still be reused for data only scheduling.

In some example, for shared resource pool, at least 1 new bit should be introduced to indicate whether the scheduling is for SL-PRS only or for SL-PRS+data. In the case when SL-PRS only is scheduled, then UE can ignore some fields, e.g., new data indicator, PSFCH-to-HARQ feedback timing indicator, PUCCH resource indicator. Otherwise, both SL-PRS and data is scheduled in the same slot(s). In both cases, the BS 102 should either implicitly or explicitly indicate UE a proper SL-PRS resource which satisfies the location requirement. Otherwise, UE randomly selects a SL-PRS resource by itself which is unknown by the BS 102, it may cause some problems when the BS 102 determines a number of PRBs/symbols should be allocated by DCI3_0 for the data transmission since it is unexpected for the BS 102 how many symbols are reserved for SL-PRS within the allocated PRBs. In order to save DCI overhead, the existing HARQ process number field can be used to implicitly indicate SL-PRS resource where one-to-one mapping can be associated by (pre-)configuration.

In some examples, for dedicated resource pool, it is similar as or may be simpler than the case with SL-PRS only for shared resource pool. If one-to-one mapping between SCI resource and SL-PRS resource is introduced, the PRS resource index can be implicitly indicated by the SCI frequency location.

In some examples, in dynamic grant type resource allocation in scheme 1, DCI 3_0 is used with the new RNTI SL-PRS-RNTI or SL-PRS-CS-RNTI for both dedicated and shared resource pool. For dedicated resource pool, SL-PRS resource ID is implicitly indicated by Frequency location of SCI. For shared resource pool, SL-PRS resource ID is implicitly indicated by HARP process ID.

In some examples, in dynamic grant type resource allocation in scheme 1, the detailed fields of DCI 3_0 are as follows or at least include one or more of the following: one new bit to indicate whether SL-PRS only or for SL-PRS+data is scheduled; resource pool index to indicate either a shared resource pool or dedicated resource pool; time gap; HARQ process and PRS resource indicator where one-to-one mapping can be pre(configured) between HARQ process ID and PRS resource ID and for SL PRS only case it is only used for PRS resource indication and for dedicated pool, this filed is ignored by UE; Lowest index of the subchannel allocation to the initial transmission; SCI format 1-A fields of frequency resource assignment; SCI format 1-A fields of time resource assignment; configuration index. For dedicated pool or shared resource pool with SL-PRS only scheduling, at least one of the following fields are ignored by UE: new data indicator, PSFCH-to-HARQ feedback timing indicator, PUCCH resource indicator, Counter sidelink assignment index.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
receiving, by a first wireless communication device from a higher layer, Sidelink Positioning Reference Signal (SL PRS) resource configuration for communicating SL PRS in a time-domain unit; and
sending, by the first wireless communication device, the SL PRS according to the SL PRS resource configuration to a second wireless communication device.

2. The wireless communication method of claim 1, wherein at least of:
time-domain configuration of a SL PRS resource of the first wireless communication device is aligned with a time-domain configuration of a SL PRS resource of a plurality of wireless communication devices;
the SL PRS resource of the first wireless communication device is Time Division Multiplexed (TDMed), comb-based multiplexed, or both TDMed and comb-based multiplexed with the SL PRS resource of the plurality of wireless communication devices within the time-domain unit;
the SL PRS resource is configured within a resource pool, the resource pool is a dedicated resource pool or a shared resource pool; or
the time-domain unit is a slot; and
the SL PRS resource configuration is received from the higher layer via signaling comprising at least one of:
LTE Positioning Protocol (LPP) from a Location Management Function (LMF);
Sidelink Positioning Protocol (SLPP) from the LMF or a wireless communication device; or
Radio Access Control (RRC) or Medium Access Control (MAC) from a Base Station (BS), the higher layer of the first wireless communication device, wherein the higher layer comprises at least one of a MAC layer, an RRC layer, or a Non-Access Stratum (NAS) layer;
or
the SL PRS resource configuration is pre-configured.

3. The wireless communication method of claim 1, wherein the SL PRS resource configuration comprises a time-domain configuration, wherein the time-domain configuration comprises at least one of a time-domain starting point, a time-domain length, or a SL PRS resource location in the time-domain unit.

4. The wireless communication method of claim 1, further comprising receiving, by the first wireless communication device, a location for an Automatic Gain Control (AGC) resource in the time-domain unit for each of at least one or a plurality resource pool, for each of at least one frequency-domain resource, for each of at least one carrier, or for a plurality of carriers used in Carrier Aggregation (CA).

5. The wireless communication method of claim 4, wherein the AGC resource is defined by at least one of an AGC time-domain resource preceding one of the SL PRS resources, an AGC time-domain resource preceding a resource used in communicating a Physical Sidelink Control Channel (PSCCH), or a starting time used for SL positioning in the time-domain resource.

6. The wireless communication method of claim 1, wherein the SL PRS resource configuration comprises configurations for time-domain SL PRS resources in the time-domain unit for each of at least one or a plurality of resource pools, for each of at least one frequency-domain resource, for each of at least one carrier, or for a plurality of carriers used in Carrier Aggregation (CA).

7. The wireless communication method of claim 1, further comprising sending, by the first wireless communication device to a plurality of wireless communication devices, a Sidelink Control Information (SCI) to indicate a number of SL PRS reservations for transmissions with or without periodic reservation, wherein at least one of:
a resource for transmitting the SCI and a SL PRS resource in the time-domain unit are mapped via a one-to-one mapping relationship;
a resource for transmitting the SCI and multiple SL PRS resources in the time-domain unit are mapped via a one-to-more mapping relationship; or
the second wireless communication device is one of the plurality of wireless communication devices.

8. The wireless communication method of claim 7, wherein the SCI reserves only a SL PRS resource belonging to a SL PRS resource packet, wherein the SL PRS resource packet comprises one or more SL PRS resources mapped to the resource for transmitting the SCI.

9. The wireless communication method of claim 1, further comprising sending, by the first wireless communication device to one of a plurality of wireless communication devices, a Sidelink Control Information (SCI) comprising a number of SL PRS resource Identifiers (IDs), wherein the number of SL PRS resource IDs is less than the number of SL PRS reservations for transmissions without periodic reservation by 1.

10. The wireless communication method of claim 1, further comprising sending, by the first wireless communication device to one of a plurality of wireless communication devices, a Sidelink Control Information (SCI) comprising a number of SL PRS resource Identifiers (IDs), wherein the number of SL PRS resource IDs is equal to the number of SL PRS reservations for transmissions without periodic reservation.

11. The wireless communication method of claim 1, further comprising sending, by the first wireless communication device to one of a plurality of wireless communication devices, a Sidelink Control Information (SCI) comprising one or multiple lists of information, wherein the information comprises at least one of: source ID, destination ID, resource reservation period, SL PRS priority, or cast type.

12. The wireless communication method of claim 1, wherein for transmitting the SL PRS, a physical layer of the first wireless communication device determines at least one of:
one or more SL PRS resources;
a resource for transmitting Sidelink Control Information (SCI);
a number of time-domain resources;
a resource pool from which the one or more SL PRS resources are to be transmitted;
a priority for SL PRS transmission;
a remaining packet delay budget;
a resource reservation period; or
a subset of resources for pre-emption and re-evaluation.

13. The wireless communication method of claim 1, wherein for transmitting the SL PRS, a high layer of the first wireless communication device determines at least one of:
one or more SL PRS resources;
a resource for transmitting Sidelink Control Information (SCI);
a number of time-domain resources;
a resource pool from which the one or more SL PRS resources are to be transmitted;
a priority for SL PRS transmission;
a remaining packet delay budget;
a resource reservation period; or
a subset of resources for pre-emption and re-evaluation, wherein the higher layer comprises at least one of a Medium Access Control (MAC) layer, a Radio Resource Control (RRC) layer, or a Non-Access Stratum (NAS) layer.

14. The wireless communication method of claim 1, wherein
the second wireless communication device receives reservation from the first wireless communication device of a first one or more SL PRS resources via a first Sidelink Control Information (SCI) in a first time-domain unit;
the second wireless communication device receives reservation of one or more SL PRS resources which is the same as the first one or more SL PRS resources from the first wireless communication device via a second SCI in a second time-domain unit;
the second wireless communication device determines that the reservation with respect to the first one or more SL PRS resources indicated in the first SCI is invalid.

15. The wireless communication method of claim 1, wherein
the second wireless communication device receives reservation from the first wireless communication device of a first one or more SL PRS resources via a first Sidelink Control Information (SCI) in a first time-domain unit;
the second wireless communication device receives reservation of one or more SL PRS resources different from the first one or more SL PRS resources from the first wireless communication device via a second SCI in a second time-domain unit;
the second wireless communication device determines that the reservation with respect to the first one or more SL PRS resources indicated in the first SCI is valid.

16. The wireless communication method of claim 1, wherein
the second wireless communication device receives reservation from the first wireless communication device of a first one or more SL PRS resource(s) via a first Sidelink Control Information (SCI) in a first time-domain unit;
the second wireless communication device receives reservation of a second one or more SL PRS resources from the first wireless communication device via a second SCI in a second time-domain unit, wherein the first SCI and the second SCI is the same PSCCH resource;
the second wireless communication device determines that the reservation with respect to the first one or more SL PRS resources indicated in the first SCI is invalid.

17. The wireless communication method of claim 1, wherein
the second wireless communication device receives reservation from the first wireless communication device of a first one or more SL PRS resources via a first Sidelink Control Information (SCI) in a first time-domain unit;
the second wireless communication device receives reservation of a second one or more SL PRS resources from the first wireless communication device via a second SCI in a second time-domain unit wherein the first SCI and the second SCI is different PSCCH resources;
the second wireless communication device determines that the reservation with respect to the first one or more SL PRS resources indicated in the first SCI is valid.

18. The wireless communication method of claim 14, wherein the first SCI and the second SCI have at least one of:
a same source ID;
a same destination ID;
a same cast type;
a same resource reservation period; or
a same SL PRS priority.

19. The wireless communication method of claim 1, further comprising at least one of:
receiving, by the first wireless communication device from a device, a User Equipment (UE) information request via LTE Positioning Protocol (LPP) or Sidelink Positioning Protocol (SLPP); or
transmitting, by the first wireless communication device to a device, a UE information report via the LPP or the SLPP.

20. A first wireless communication device, comprising:
at least one processor configured to:
receive, via a transceiver from a higher layer, Sidelink Positioning Reference Signal (SL PRS) resource configuration for communicating SL PRS in a time-domain unit; and
send, via the transceiver, the SL PRS according to the SL PRS resource configuration to a second wireless communication device.
